(19) United States
(12) Patent Application Publication
(10) Pub. No.: US 2008/0302119 A1
(43) Pub. Date: Dec. 11, 2008

(54) SYSTEM AND METHOD FOR DELIVERING REFRIGERATED AIR WITHIN A VEHICLE

(76) Inventor: LUKE N. SHAW, GOSHEN, IN (US)

Correspondence Address: Buchanan Intellectual Property Office LLC, P.O. Box 700, Perrysburg, OH, 43552-0700, US

(21) Appl. No.: 12/133,554

(22) Filed: Jun. 5, 2008

Related U.S. Application Data
(60) Provisional application No. 60/942,100, filed on Jun. 5, 2007.

(51) Int. Cl. B60H 1/32

(52) U.S. Cl. 62/241; 62/61; 62/406

(57) ABSTRACT

A system for refrigerating ambient air flowing into a moving racing vehicle and delivering it to the passenger compartment, such as through the driver seat, into a helmet, driver's suit, and/or other locations within the cockpit to mitigate the effects of excessive heat, or to cool mechanical or electrical components of the vehicle. The system includes a coolant container unit, such an insulated cooler having inflow and outflow ports connected to a delivery conduit system, that receives fresh air from the vehicle's air intake system and directs it through a conduit system, such as coiled cooper tubing which is surrounded by an endothermic material dry ice (CO₂), thus refrigerating the air for distribution via the delivery conduit system to a desired location within the cockpit of the vehicle or a location such a the brake system. The system may also include a powered air-accelerating means, such as a motorized fan, to supply a source of accelerated air into the coolant container unit, which can be figured to refrigerate air below 15° F.

### CROSS REFERENCE TO RELATED APPLICATION

This application claims priority to U.S. Provisional Application Ser. No. 60/942,100, filed on Jun. 5, 2007, the entire contents of which are hereby incorporated by reference into this disclosure.

### FIELD

This invention relates to air refrigeration equipment, more particularly to a system for delivering refrigerated air using an endothermic coolant material.

### BACKGROUND

Providing comfort for a race driver, particularly in closed cockpit forms of motor racing, has long represented a difficult challenge. There is evidence that temperatures inside a race car's cockpit can easily reach 140 to 160 degrees or more, depending on the vehicle, track, and weather conditions. The engine firewall, transmission tunnel, and floor each radiate heat into the cockpit. In certain forms of racing, the oil pan is located directly behind the seat which typically comprises a padded solid metal frame, meaning that the driver is in direct contact with a hot surface over much of his or her body during the race. In fact, the high temperatures that are generated inside the cockpit have been known to cause burns and blisters. Perhaps more importantly, prolonged exposure under hyperthermia-inducing conditions can lead to exhaustion and degrade concentration and reflexes, sometimes leading to critical errors being made during competition. Unfortunately, the driver's safety equipment, which includes fireproof racing suits and a full helmet, typically compounds the problem by interfering with the dissipation of body heat. In addition to impacting the driver, extreme cockpit heat has been known to be a factor in damaging sensitive instrumentation, such as certain electronics or other control systems within the vehicle.

Addressing the problem of cooling the driver during a race is complicated by the fact that electrical power, which would permit operation of standard air or liquid refrigeration units (air conditioners) like those found in regular passenger vehicles, cannot be diverted for such ‘luxuries’ as driver comfort, lest the driver and team be put at a power (and a possible weight) disadvantage relative to other competitors. Electric fans for forcing air to the driver can operate on low voltage/battery power, but offer limited relief. Insulation around heat-generating components and surfaces can help mitigate the problem, but also provides for limited improvement in comfort. Infusion of liquid coolant into the driver's suit has been attempted; however, it has not found wide acceptance because the liquid typically elevates in temperature during race to a point where it actually can contribute to the problem it is intended to address. Channeling of ambient air through ductwork leading to the suit or driver's seat offers little relief in the extreme environment race car, although seat ventilation systems have been suggested for use in passenger cars.

A more recent invention for improving driver comfort has been the ‘cool box’ a small cooler-like container, either metal or plastic, located within the interior of the vehicle. The box has an air intake that is connected via a hose to one of the aero-vents on the race car and an outflow port that is connected to the driver's helmet via a second hose or tube. One or more packs of a frozen gel coolant, such as BLUE ICE® brand or a similar material, is placed within the box. Air flows into the box and is chilled by the coolant, typically with the assistance of a pump-like fan. The chilled air; which is typically about 20 degrees below the ambient temperature, flows through the helmet and is blown onto the drivers head, providing some relief. A problem is that the temperature of the air rises during the course of the race as the frozen gel melts, eventually resulting in warm air being blown about the driver's face. Condensation is a problem that must be addressed as well. Coolant materials that have the ability to chill the air to an even greater degree and/or have the ability to last much longer, are typically either not suitable for direct contact with the driver's skin or not safe to be inhaled in elevated concentrations. Thus, the ‘cool box’ system has found only limited acceptance as well.

What is needed is a cooling system for a race car driver that does not rely on an external power source, is safe for the driver, and provides a significant improvement in driver comfort for the duration of the competition.

### SUMMARY OF EXEMPLARY EMBODIMENTS

The foregoing problems are solved and a technical advance is achieved in an illustrative refrigerated air delivery system that does not rely on an external power source to deliver a stream of refrigerated air to the cockpit or passenger compartment of a vehicle, such as a race car or truck, to cool the driver and/or potentially heat-sensitive instrumentation. In one embodiment of the present invention, the system comprises a driver seat that includes an air distribution system comprising tubing, ducts, or other conduit for cooling the seat and driver; and a coolant container unit (e.g., a standard insulated cooler) having one or more inflow and outflow ports and being configured for receiving a endothermic coolant material within, such as solid form CO₂ (dry ice). The coolant container, which does not require a supplemental power source for refrigeration of the coolant material, is connectable to a delivery conduit system which receives outflowing air from the container unit, and an inflow conduit that is connectable to an air intake system, such as an side intake or fresh air vent (also called the aerovent) located on the side of the vehicle so that ambient or fresh air flow from outside of the vehicle) is directed into the system and through the coolant container unit to the seat, cooling the driver while the vehicle is in motion. In one embodiment, the coolant container unit is configured with the inflow port on top and the outflow port beneath such that airflow is gravity assisted. Preferably, the delivery conduit system includes a series of tubing diameter reductions that help accelerate the air flow velocity, which advantageously provides a jet effect at the endpoint(s) of the system, such as air distribution ports or jets disposed about the drive seat in selected locations. Optionally, the refrigerated air can be at least partially diverted to cool other areas or components or materials within the vehicle, such as sensitive electronics (including batteries), which can be damaged by exposure to extreme heat within the cockpit.

In a first aspect of the invention, the air distribution system comprises a plurality of air distribution ports that are strategically arranged about the driver seat such they deliver air to different areas of the driver's body when situated therein, such as the upper legs, upper and lower torso, and neck. In one embodiment, the plurality of air jets comprise apertures formed through the seat padding which are fed by individual air feeder tubes comprising the terminal portion of an air delivery conduit system. The air delivery conduit system a first and a second outflow tube, each having a first diameter, which comprise the outflow conduit, each being connectable to the coolant container unit. The first and second outflow conduit tubes are connected to a first and second main feeding tube, respectively, which comprise a second, smaller diameter, which supply refrigerated air to system of yet smaller tubing that directs the air to the air distribution ports distributed about the driver seat. In the illustrative embodiment, the right and left main feeder tubes are connected to a connector, such a plastic T-fitting, that directs air upward via seatback feeder tubes to supply air to the air jets along either the right or left side of the seat back, with a second branch routing air through a central connector that joins air directed from the opposite of the right or left feeder tubes. The central connector then feeds a seat bottom feeder tube that branches underneath the seat to supply air to the air distribution ports or jets of the right and left sides of the seat bottom. Optionally, the air distribution system includes one or more control mechanism configured to augment, reduce, or block the flow of air to the driver. These include fans, valves, baffles, etc. which are electrically, pneumatically hydraulically, or mechanically operated by the drivers or thermostatic control system.

In a second aspect of the invention, the delivery conduit system comprises a plurality of channels extending through the seat through which the refrigerated air passes, thus cooling the seat surface contacting the driver. The refrigerated air moving through the tubes and channels is then directed out of the seat and into the cockpit or vented from the vehicle.

In a third aspect of the invention the delivery conduit system is adapted to at least partially or selectively direct refrigerated air to a second or different location within the vehicle, such as to cool potentially heat-sensitive instrumentation, such as electronics.

In a fourth aspect of the invention, the cooler container unit comprises a conduit, such as a coiled copper metal tubing, through which the accelerated air is directed. The air flowing through the conduit pathway is chilled due to contact with the conduit surface, which may reach minus 109° F. when dry ice is used within the sealed container unit, thereby resulting in lower temperature air output (e.g., less than 15° F.). The airflow pathway is isolated from the interior space of the container until so that the coolant sublimate (e.g., CO₂ gas) is not introduced thereinto and delivered to the cockpit or driver.

Additional understanding of the invention can be obtained with review of the detailed description of exemplary embodiments, below, and the appended drawings illustrating various exemplary embodiments.

### BRIEF DESCRIPTION OF THE DRAWINGS

Embodiments of the present invention will now be described by way of example with reference to the accompanying drawings, in which:

FIG. 1 depicts a perspective view of an illustrative refrigerated air delivery system of the present invention;

FIG. 2 depicts a schematic top view of race car and the embodiment of FIG. 1;

FIG. 3 depicts a perspective view of the delivery conduit system attached to the back of the vehicle seat of FIG. 1;

FIG. 4 depicts a perspective view of the feeder tubing attached to the bottom of the seat of FIG. 1;

FIG. 5 depicts an exploded view of the air jet assembly of the embodiment of FIG. 1;

FIG. 6 depicts cross-sectional view of the air jet assembly of FIG. 5 within the seat;

FIG. 7 depicts a top, partially sectioned view of a coolant container unit;

FIG. 8 depicts a perspective view of the coolant container of FIG. 7;

FIG. 9 depicts a schematic view of the system of the present invention in which the outflow delivery conduits includes first and second pathways for cooling a first and a second location within the vehicle;

FIG. 10 depicts a schematic view of a vehicle seat of the present invention in which refrigerated air is directed through a series of internal channels;

FIG. 11 depicts a partially sectioned perspective view of an alternative coolant container of the present invention.

FIG. 12 depicts a perspective view embodiment of an opened coolant container unit that comprises a coiled conduit extending therethrough;

FIG. 13 depicts a perspective view of the embodiment of FIG. 12 sealed and connected to inflow and outflow conduits;

FIG. 14 depicts a perspective view of the embodiment of FIG. 12 directing airflow to two locations; and

FIG. 15 depicts a perspective view of the embodiment of FIG. 14 connected to a powered air accelerating means.

### DETAILED DESCRIPTION OF EXEMPLARY EMBODIMENTS

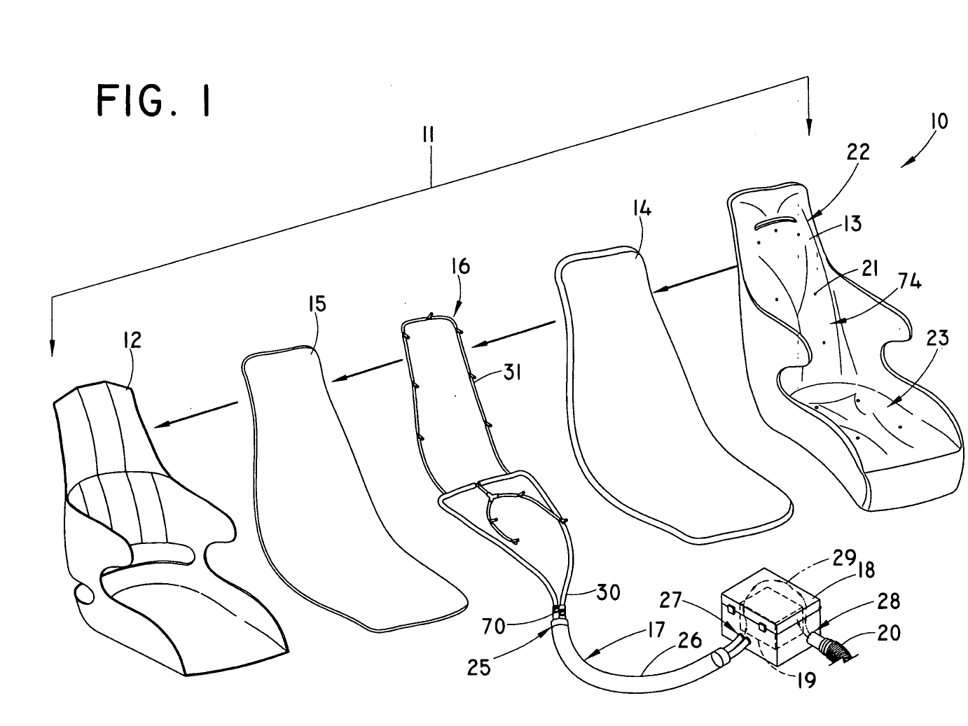

FIGS. 1-15 depict selected embodiments of a system for delivering refrigerated air to at least a first location within the cockpit 38 or passenger compartment of a vehicle, such as for cooling one or more locations, such as the a race driver and/or heat-sensitive instrumentation, the system relying on motion of the vehicle to direct the inflowing air through a coolant container unit 18 connected to a delivery conduit system 16 for distribution, such as to the driver seat assembly 11 where it is blown onto the driver. FIG. 1 depicts one illustrative embodiment of the present refrigerated air delivery system 10 comprising an inflow or intake conduit 20 for receiving ambient (fresh) air from outside of the vehicle, a coolant container unit 18 that includes an inflow port 28 connected to the intake conduit 20, the coolant container unit 18 being configured to receive a coolant material 19, such as dry ice (e.g., an approximately 10-20 lb. block or a similar amount of dry ice pellets), a frozen gel coolant, or any suitable non-hazardous solid or fluid material having the ability to refrigerate air when placed in contact therewith. Typically, dry ice has the ability to produce air refrigerated air of a temperature of approximately 25-35° F. (e.g. 30°) in the present system, while frozen gel coolant would produce about 50-55° F. air within the system. The illustrative coolant container unit 18, which comprises a insulated box, such modified beverage cooler or a similar unit (e.g., the cooler unit comprising part of a Parker Pumper Fresh Air System, ALLSTAR® Performance), is connectable to a delivery conduit system 16 that includes an outflow means from the coolant container unit 18, such as the illustrative pair of outflow ports 27 which supply the outflow conduit 17 which comprises first and second rubber tubing wire tied or zip tied together and encased in a thermal cloth or insulating material 26, that connects to the coolant container unit 18. The thermal cloth 26 can comprise a hook and loop fastening means to make it readily removable from the outflow conduit 17. While the illustrative the inflow and outflow means 27,28 located about the coolant container unit 18 comprises ports that are connectable to conduit or tubing comprising the refrigerated air delivery system 10, the configuration of the openings that allows air to enter or exit the coolant container unit 18 is not critical for an understanding of the invention.

FIGS. 7-8 depict an embodiment of an cooler container unit 18 that is modified from a standard personal beverage cooler or ice chest (e.g., 12 quart) that is sized to contain an appropriate amount of coolant material, the structural modifications include an inflow port 28 and a pair of outflow ports 27 adjacent to one another along one side (e.g., a narrower width side) of the container. The ports 27,28 are separated by a baffle 65 that directs the airflow 29 around a centrally located inner container 62 that houses the coolant material 19 therein. In the illustrative embodiment, the inner container 62 comprises a metal box or cage portion 63 that optionally includes one or more open areas 66 along one or more side thereof (depicted in FIG. 8) that allow the air to come in direct contact with the coolant material. An inner retaining barrier 64, such as a screen, mesh, grate, etc., advantageously prevents pellet-size materials or smaller pieces from block ice from exiting the inner container 62 and entering the outflow conduit 17. Additionally, an inline screen 68 (e.g, plastic mesh) can be placed at the inflow port 28 or elsewhere in refrigerated air delivery system 10 (preferably between the intake vent 33 and container unit 18) to prevent rocks, track debris, or other material from entering and exiting the container unit, where it can then lodge in the smaller-diameter conduit downstream and at least partially obstruct airflow. Preferably, the screen and/or screen housing assembly is made easily removable for rapid cleaning or replacement in the event it becomes clogged during competition.

An alternative coolant container 18 embodiment is depicted in FIG. 11 in which the inflow port 28 is located about the top of the coolant container unit 18 and the outflow ports 27 are located at the bottom of the unit such that airflow 29 is gravity assisted as it passes from the inflow conduit 20, through the cooler container unit 18, and out of the outflow conduit 17. In the illustrative embodiment, a block of dry ice or other coolant material 19 is placed over a bottom grate 76 or screen that keeps the material from blocking the outflow ports 27 and bits of material from entering the system. The block of coolant material 19 can be sized to allow airflow 29 to pass therearound and out through the delivery conduit system 16. To allow movement of the air through coolant material 19, optional channels 77 can be drilled therethrough, allowing the block of ice to assume the full inner dimensions of the coolant container unit 19. It should be noted that the configuration of the coolant container unit is not particularly critical to the understanding of the invention. It may comprise any appropriate modified or custom-built container unit that is configured for directing air around a coolant material contained therein and which is connectable to an inflow and outflow means.

Referring to both FIGS. 1 and 3, the illustrative outflow conduit 17 comprises a pair of rubber hoses 25 of a first diameter, such as standard 0.5″ OD tubing or ⅝″ ID heater hose, encased in an insulating material 26. It should be noted that the described materials of various components of the conduit system are merely exemplary and are not critical to an understanding of the invention. The first-diameter conduit tubing 25 is connected to conduit tubing 30 of smaller, second diameter, such as standard ⅜″ OD (¼″ ID) clear vinyl tubing, which in turn, is connected to conduit tubing 31 of a third, smaller diameter; such as ¼″ OD ( 3/16″ ID) clear vinyl tubing, which supplies the refrigerated air to a series of air distribution ports 21 distributed at strategic locations about the seat back 22 and seat bottom 23 of the driver seat 13 for maximizing driver comfort. The reductions in the diameter of the tubing helps create a Venturi effect which increases the air flow velocity as airflow progresses through the system. For nomenclature purposes, the illustrative driver seat assembly 11, although comprising multiple air distribution ports 21 that collectively comprise the termination 74 of the refrigerated air delivery system 10, is considered to comprise the ‘first location’ to which the refrigerated air is delivered in this particular embodiment. A ‘second location’, if also present, would comprise an additional site located about the passenger compartment (other than the seat) to which the refrigerated air is separately directed.

The driver seat portion 13 is one component of the seat assembly 11, which also includes a foam sheet 14, such as No. 2-6 cross-linked EVA polyethanol foam (e.g., 4), to encase and protect the delivery conduit system 16, an outer insulating blanket 15, such as flame-retardant fiberglass duct insulation, and a metal seat frame 12 which is bolted or otherwise attached to the frame of the vehicle and which supports the seat portion 13 to which it is attached (illustrative model manufactured by Kirkey Racing Fabrication, Inc., Rooseveltown, N.Y.). The illustrative delivery conduit system 16 preferably, but not necessarily enters the seat via the right or left front low corner between the frame 12 and foam blanket external 14 (and insulation blanket 15) to the seat bottom 23. The first diameter tubing 25 connects to second-diameter vinyl tubing 30 which extends to the back of the seat where it is connected to a third diameter of tubing 31, these reductions being primarily responsible for the increase in velocity of the airflow exiting the coolant container unit 18.

FIG. 3 depicts the illustrative configuration of the delivery conduit system 16, which comprises a first 40 and second 41 portion of the second-diameter tubing 30 (each connected to the first and second (first diameter) rubber hoses 25 via standard hose clamps), which attach to connectors 42, such as standard barbed T-connectors (Eldon James, Loveland Colo.) which in turn, connect to both the third-diameter tubing 31 (the seat back feeder tubing 49 that feeds the jet feeder connectors 48) and a centrally located T-connector 43 that connects to the seat bottom delivery conduit system 44 that supplies air to the seat bottom portion 23. As shown in FIG. 4, the seat bottom delivery conduit system 44 comprises a standard barbed Y-connector 45 that supplies a first and a second branch 46,47 of third-diameter tubing that supplies the right and left side jet feeder connectors 48 of the seat bottom 23. The illustrative delivery conduit system 16 of the seat back 22 and seat bottom 23 is advantageously located in a recessed channel 50 in the foam blanket 14 and foam portion 60 of the seat bottom, respectively, to protect the tubing from being compressed or damaged, which could interrupt the flow of air.

The illustrative delivery conduit system 16 receives refrigerated air from the outflow conduit 17 which is ultimately directed to 11 air distribution ports 21, comprising air jet assemblies 52 distributed along the seat back 22 and set bottom 23. The seven ports 21 located on the seat back portion 22 are strategically positioned to direct air to the drivers neck (1), shoulders (2), upper back (2), and lower back (2). The four ports of the seat bottom portion 23 cool the driver's buttock (2) and thigh areas (2). The number and distribution of the air ports may be quite variable and is not critical to an understanding of the invention. In the illustrative embodiment, the system 10 is configured to achieve a high flow rate (e.g., 90-175 ft³/min) with a relatively low constant pressure (e.g., less than 20 psi).

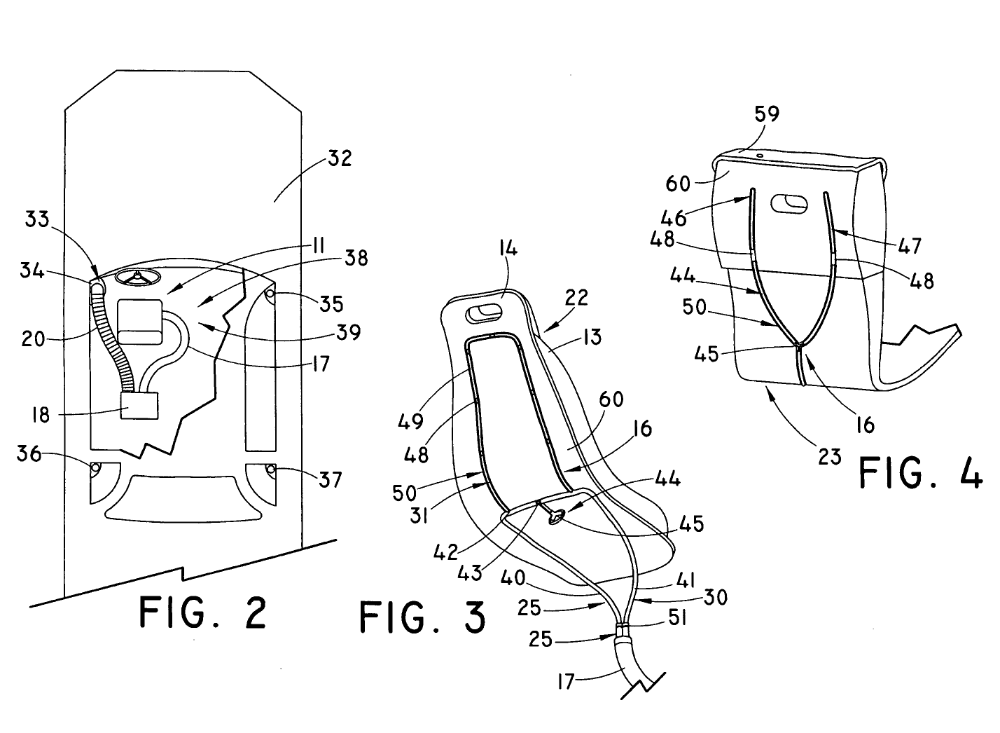

FIG. 2 depicts one example of how the present refrigerated air delivery system 10 can be configured. The illustrative inflow conduit 20 is connected to an air flow intake vent 33 located at the left front corner 34 of the cockpit 38. The connecting portion may be tapered to insert into air flow intake vent 33 and secured with a standard hose clamp (not pictured). The coolant container unit 18, which is connected to the opposite end of the inflow conduit 20, is located behind the drivers' seat assembly 11. The entrance opening 28 in the coolant container unit 18 (FIG. 1) is typically 2.0-5.5″ in diameter, more preferably 2.5-3.5″. The illustrative outflow conduit 17, connects to a pair of 0.5-2.0″ of outflow ports 27 (more preferably 0.75-1.5″) via threaded connector or some other suitable means, then connects to the delivery conduit system 16. Alternate configurations include having the inflow conduit 20 connect to the left rear air flow intake vent 36. The right front 35 and right rear 37 air flow intake vents can also supply air to the system via the inflow conduit 20, whereby the coolant container unit 18 may be located the right side of the cockpit 38, e.g., beside the driver seat assembly 11. The inflow conduit 20 can comprise a plurality of conduits/hoses rather than the single one depicted. Furthermore, the inflow conduit 20 can be connected to more than one air flow intake vent 33 (e.g., both the left front 34 and left rear 36 vents. Generally, the inflow conduit 20 is connected to a particular vent or vents which, because of the configuration of the track, offers the best flow of air into the system 10.

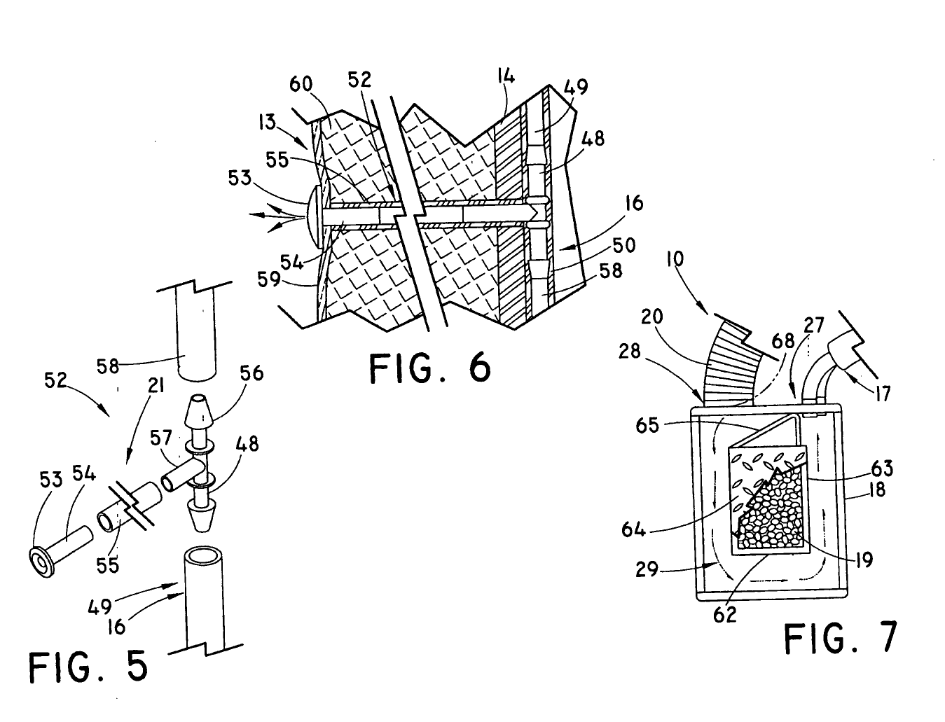

FIGS. 5-6 depict one embodiment of an air jet assembly 52 that directs pressurized air flowing through the delivery conduit system 16 to the driver via a series of illustrative air distribution ports 21. The air jet assembly 52 comprises a jet feeder connector 48, such as the modified 3/16 high density polyethylene T-connector (Eldon James) that is attached to the third-diameter ( 3/16″ I.D.) vinyl tubing 31 of the seat back feeder system 49 (or set bottom feeder system 44), which engages the two oppositely placed connector barbs 56 of the jet feeder connector. The seat back feeder system 49 comprises a plurality of tubing sections 58 that are interconnected by the plurality of jet feeder connector 48 distributed about the set back 22. The illustrative jet feeder connector 48 further includes a barbless central leg 57 that is inserted into the jet feeder tube 55 that traverses the foam portion 60 of the seat portion 13 to connect to the air distribution jet 21 that traverses the seat covering 59 and provides a means for the refrigerated air to exit the system and cool the driver that is positioned adjacent the seat covering. The illustrative two-piece air distribution jet 21 comprises a ⅝″ O.D. Neoprene Washer 53 with a gold flared insert tube 54 (e.g., available from Anderson Barrows) inserted therethrough. The jet feeder tube is advantageously sized such that the air distribution jet is held securely again the outside of the seat covering 59. Alternatively, the washer 53 can be secured to the seat covering 59 by adhesive, a tethering mechanism, or another well-known means.

FIG. 10 depicts a second driver seat 11 embodiment in which rather than the refrigerated air being directed out of the air distribution port onto the driver, the air is circulated through a series of cooling channels 75 formed within the seat portion 13 to lower the temperature of the seat surface. At the termination 74 of the delivery conduit system 16, the refrigerated air is either vented to a second location 73 within vehicle, as shown, such as to cool electronics, or vented out of the cockpit area. Alternatively, the driver seat 11 can include a combination of cooling channels 75 and air distribution ports.

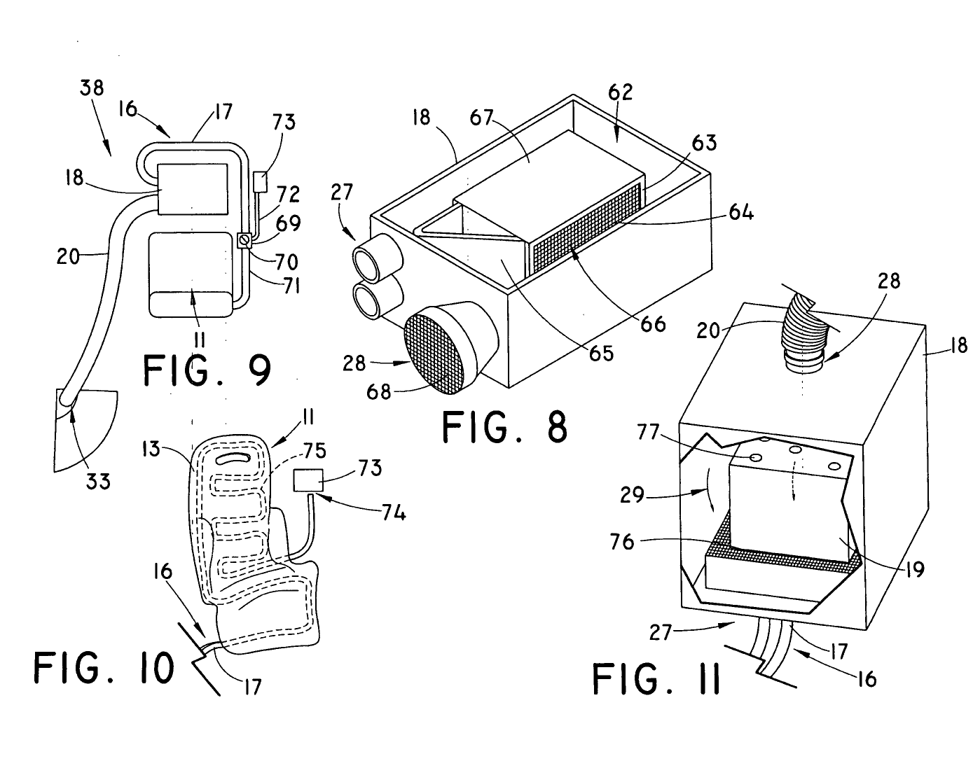

In another embodiment the present system of using refrigerated air for cooling a second or alternate location 73 within the cockpit of a vehicle, depicted in FIG. 9, the outflow conduit 17 include a first and second outflow pathways 71,72 which supply the driver seat and/or a second location 73, such as potentially heat-sensitive instrumentations, such as an electronic module located within the cockpit of the vehicle. In the illustrative embodiment, the outflow conduit 17 connects to a junction 69 (e.g. ‘Y’ connector) that splits the conduit into a first outflow pathway 71 that delivers refrigerated air to the driver seat 11, and a second outflow pathway 72 that directs air to a second location 73, such as the aforementioned example of an electronics module located behind the driver. The illustrative junction 69 includes a control valve 70, such as a standard ball valve, that is configured to allow the driver to advantageously select how the refrigerated air is directed through the system, such as to open or close a particular outflow pathway (or both at the same time) or split the airflow such that it is simultaneously directed into both the first and second outflow pathways 71,72 (either equally or proportionally). Other embodiments include having the second outflow pathway 72 rejoin the first outflow pathway at a point past the second location 73 being cooled (this being optionally controllable to bypass the second location), or having the refrigerated air being directed to the second location along a single outflow pathway before it is delivered to the driver seat 11. Additional locations may also included along the outflow conduit system by using a control valve with more than two positions. Alternatively, one or more control valves 70 can be place inline before a single location, such as the seat 11, as depicted in FIG. 1, so that the driver can shut off the flow of air in the event that he or she becomes uncomfortable due to an excessive drop in temperature, or if the coolant has been exhausted and the airflow ceases to perform its intended function.

The illustrative air distribution jets, connectors, and conduit system comprise standard available components and are merely exemplary for the purpose of demonstrating a practical, operative embodiment of the present invention. One would appreciate that these components could be combined or modified in any number of ways to produce a system capable of delivering air from the coolant container unit to the seat and driver (or other locations). For example, the entire air delivery conduit system can be extruded or constructed as a single piece or unit, thereby eliminating most or all of the individual connectors. The air distribution ports can be formed as a single piece or eliminated by having the conduit tubing direct the air to the driver via a series of apertures (air distribution ports) in the seat covering. In other examples, the coolant container unit may be located inline within the conduit system, rather than being a box or separate unit or it may be located about the terminal location (e.g., within the seat), such that the delivery conduit system is greatly reduced in length, or is limited to one or more air distribution jets or the outflow port itself.

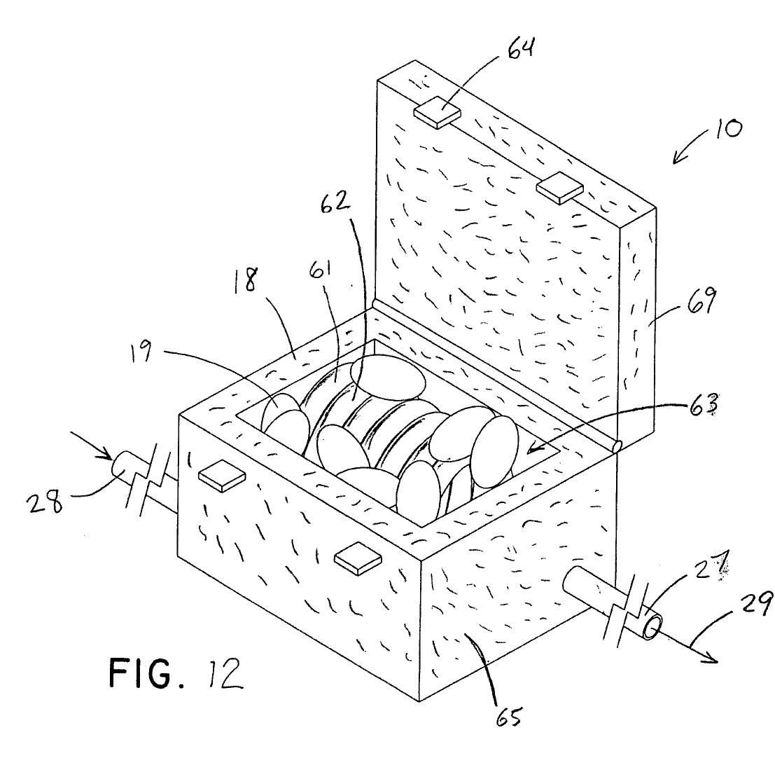

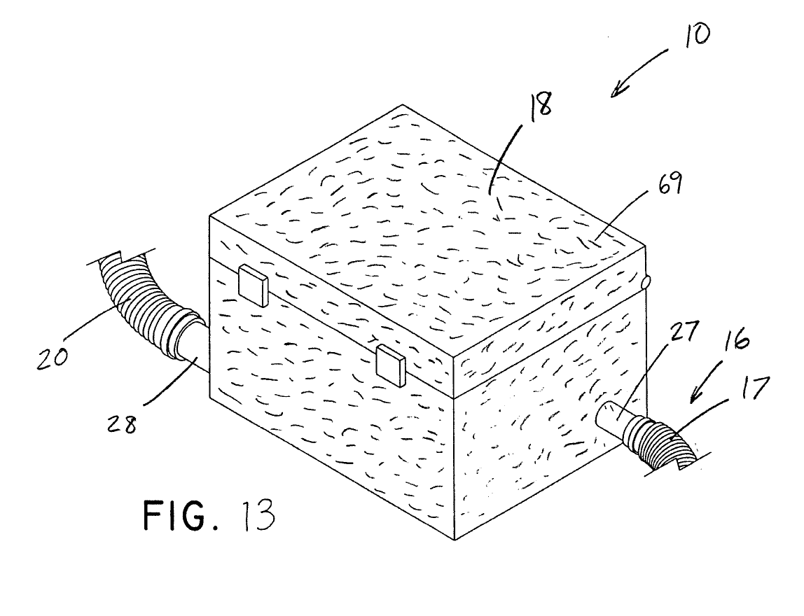

FIGS. 12-15 depict an embodiment of the present invention in which the airflow pathway 29 through the container unit 18 is directed through a thermally conductive conduit 61, such as copper tubing (not necessarily circular in cross-section), comprising a series of coils 62 so that the airflow 29 (e.g., ambient air received into the inflow conduit 20 via an outside vents) remains isolated from the interior space 63 and coolant material 19 of the container unit 18, which is preferably sealed to prevent the flow of ambient air into or out of the interior space. Thus, the refrigerated air does not come into direct contact with the coolant 19 within the container unit 18, as with some of the embodiments depicted in the earlier figures. As such, the sublimate (e.g., CO² gas from dry ice) is not introduced into the airflow pathway and distributed out through the air delivery system 16. Rather, the air is refrigerated by contact with the inner surface of the copper tube conduit, which if dry ice is used as the coolant 19, may be cooled to about minus 109° F. via direct contact with the surrounding coolant 19 inside the container unit 18. This advantageously results in purer, natural air being fed to the driver, preventing undesirable CO₂ gas accumulation within the cockpit, driver's helmet, etc., while significantly increasing the life of a sublimating coolant 19 like dry ice insomuch that contact between dry ice and the flowing air accelerates the sublimation process.

FIG. 12 depicts an exemplary embodiment in which the container unit 18 comprises a standard plastic cooler, about 15″ in length and 11″ in width, which is modified by the addition of insulated foil wrap 65 around internal and external surfaces of the container and a pair of latches 64, secured by pins, to secure the lid of the cooler to the portion that includes the interior space 63 and the conduit coil 62 therein. In the illustrative embodiment, 12-13 feet of soft copper tubing (0.75″ I.D.) comprises the thermally conductive conduit 61 which is formed into a series of seven adjacent coils 62, approximately 17-18″ in circumference, that are sized to fit within the interior space 63 of the container unit 18. Alternatively, aluminum or other types of metal tubing or conduit 61 may be used as well, either bent, cast, or otherwise formed into an appropriate configuration for creating a closed pathway to traverse the coolant container unit 18. A pair of copper elbow (not shown) are attached at each end of the coil and attached in turn to shorter section of copper tubing that comprise the inflow port 28 and the outflow port 27, which each extend out of the container unit 18 through apertures formed through the walls of the cooler. In the illustrative embodiment, approximately seven pounds of dry ice pellets is used to fill the available interior space 63 surrounding the coils 62, this amount varying according to the size and configuration of the container unit 18. When the container lid 69 closed and latches 64 secured to create is proper seal (FIG. 13), the amount of sublimation is minimized such that the dry ice will supply optimal refrigeration for an entire day (up to 24 hours) until such time when the container should be opened to prevent overpressurization of and damage to the container unit from sublimate gas buildup. Optionally, air may be evacuated from the interior space of the container unit 18 via a valve port (not shown) or other means such that the sublimation process is substantially halted, preventing such a buildup of gas within the container unit and increasing the life of the dry ice, provided the seals around the ports and the lid are sufficient to maintain the vacuum. The valve may be operated manually or automatically, using commonly available technology such as a electronically or mechanically actuated relief valve.

Thermally conductive conduit 61, such as copper tubing, formed into coiled or serpentine configuration 62 in combination with an particularly effective endothermic coolant, such as dry ice, can produce refrigerated air at the outflow port that is significantly lower in temperature than other cooling systems using frozen gel/ice or having a shorter pathway that limits the exposure of the flowing air to the coolant or chilled surfaces within the container. It should be noted that ‘coiled’ may be defined as including either rounded or squared shape coils in any orientation. The term ‘serpentine’ may be defined as including any configuration in which the airflow pathway and conduit is redirected and lengthened via a series of bends within the container to maximize or increase contact between the air and the cooled surface of the conduit. Testing by the applicant has shown that the seven-coil conduit configuration depicted in FIG. 1 and including about 12.5′ of copper tubing can provide refrigerated air 29 outflow having a temperature of approximately 2° F. One skilled in the art would be able to produce a desired refrigerated outflow air temperature by configuring the pathway to control the amount of exposure at the air/conduit interface. For example, each additional coil lengthens the pathway to allow the air to be cooled about 15° below ambient temperature, depending on the tubing I.D., diameter, and other factors. Thus, the extremely hot ambient air temperatures typical on a racing track (usually well over 100° F.) can be effectively reduced to an air outflow temperatures below 25°, 20°, 15°, 10°, 5° F., or even lower; depending on the configuration of the coils, given that the conduit itself is typically colder than 100° F. below zero. A coiled configuration, while perhaps being most efficient in terms of space, is not essential to the present invention and other pathways (e.g., serpentine) may be contemplated, particularly one that lengthens the pathway within the coolant container unit. Additionally, multiple conduit pathways (separate coils), e.g., including multiple inflow and/or outflow ports, may be used within a single container unit, such as to deliver refrigerated air of different temperatures or velocities. The illustrative configuration showing an inflow port 28 at one end of the container unit 18 and an outflow port 27 at the opposite end is also exemplary with alternate arrangements, such as that shown in FIGS. 1 and 7, being possible as well.

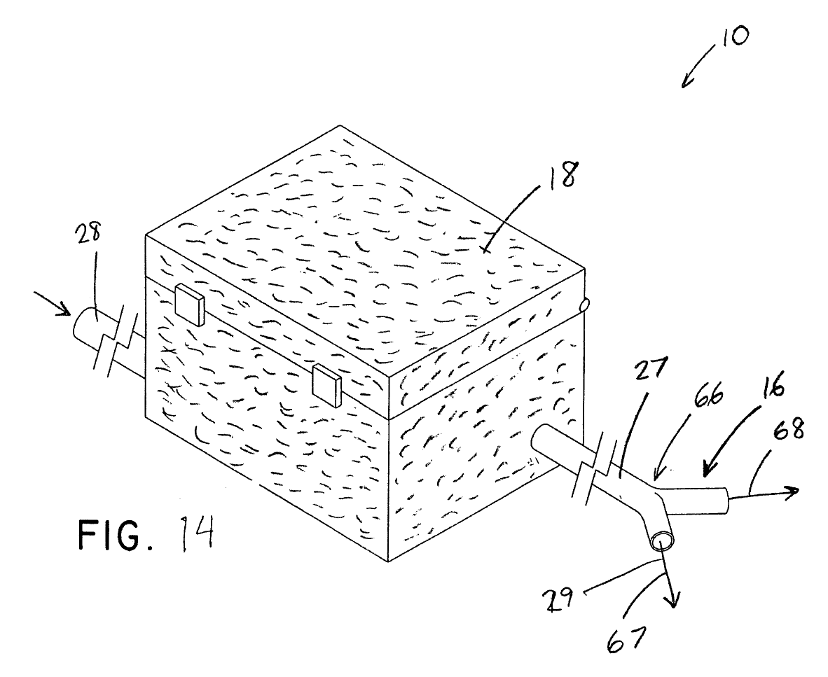

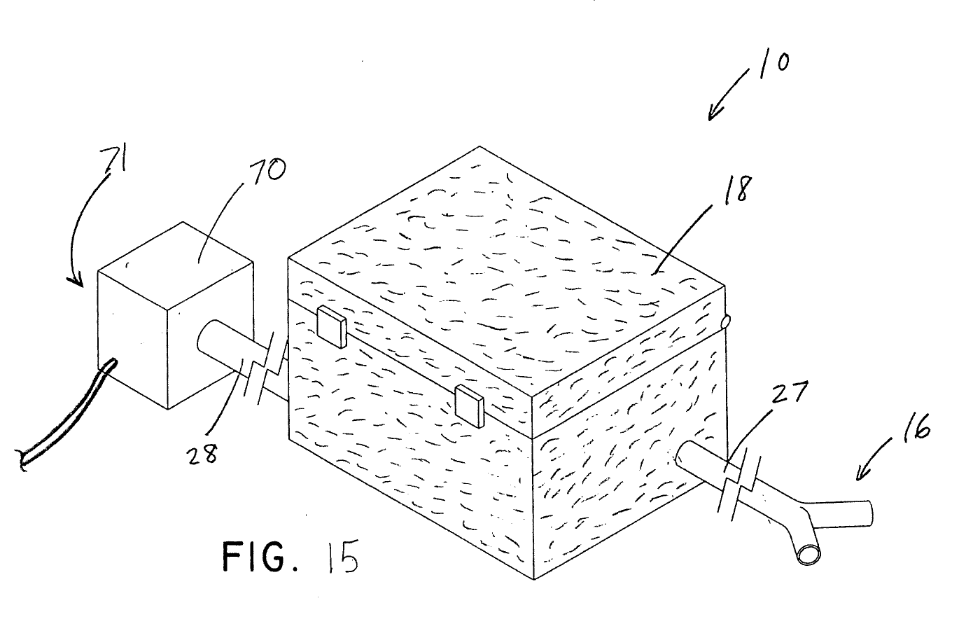

FIG. 13 depicts the embodiment of FIG. 12 in which the container unit 18 is sealed in a closed configuration with the inflow port 28 being connected to the inflow conduit 20, which receives ambient air from one or more vents 34,35 (see FIG. 2) located about the vehicle. The lower temperature of the refrigerated air made possible in this embodiment having a coiled copper tubing conduit may result in fewer vents being necessary, which can decrease the aerodynamic drag on the vehicle. The outflow conduit 17 of the air delivery system 16 supplying refrigerated air to the cockpit space, the drivers equipment (suit, helmet, seat, etc.), or electrical or mechanical components of the car, is connected to the outflow port 27 by clamps or other means. As depicted in FIG. 14, the outflow port 27 or the air delivery system 16 itself may comprise a branched configuration 66 to split the refrigerated air into a first pathway 67 and a second pathway 68, which in turn may comprise further branching points distal to the main branch. This would be advantageous where one pathway is used to supply cool air to the driver (seat, helmet, suit, feet, etc.) while another pathway can be directed to one or more a component of the vehicle, such as the brakes (e.g, to prevent fracture of the rotors due to heat), oil pan, sensitive electronics, etc. To adjust the temperature of the refrigerated air so that it is safe and comfortable to the driver, the tubing leading to the helmet or other selected destinations can be lengthened or redirected through a warmer location within the vehicle to allow the temperature to rise somewhat, while still allowing the colder air flowing through other pathways to remain at a lower temperature. The temperature of the refrigerated air may also be adjusted by mixing the air within a line or pathway with an incoming line of unrefrigerated ambient air (e.g., directly from one of the vents). This may be accomplished with a valve or other system that is electronically or mechanically controlled by the driver or a computer.

While the present invention is intended as a system that does not rely on an external power source, such as an electric fan, to propel the air therethrough, it is within the scope of the invention to include a supplemental fan or other well-known air-accelerating means within the system to provide a constant or occasional supplement to motion-directed flow, or provide a means to cool the driver or cockpit while the vehicle is temporarily idled, such as during a pit stop. Preferably, such a supplementary apparatus or system would either be fully controllable by the driver, or it would include an automatic control system that powered on when needed (e.g., utilizing a thermostat), such when the system temperature exceeded a certain level or the vehicle has decelerated below a certain speed such that inflowing air is no longer sufficient to providing adequate cooling. Furthermore, the embodiment of FIGS. 12-14 may be adapted to include its own powered fan or other air-accelerating means, or be connected to an existing one, so that the cooler container unit 18 may be used within another environment to supply refrigerated air where a standard AC unit is not practical—or the benefits of much cooler air possible with the exemplary embodiment of FIG. 12-14 is especially desirable. This is depicted in FIG. 15, which shows the embodiment of FIG. 14 which is connected to powered fan unit 70 which receives ambient air via a inflow vent 71 (which may or may not be connected to a inflow conduit). The fan unit 70 can be plugged into or powered by any AC or DC power source to operate the fan motor. Alternatively, the fan/motor or other air accelerating mean can be made integral with the container unit 18, such as being located within a housing adjacent thereto so that the inflow port 28 directs the accelerated ambient air directly into the conduit within the unit.

Still referring to the embodiments shown in FIGS. 12-15, another optional component of the system is an inline box or container, similar to the one housing the fan depicted as element 70 in FIG. 15, that provides a means for removing moisture from the ambient air prior to it entering the inflow port 28 of the container unit 18. Under particularly humid conditions, condensation from the rapidly cooled air can form inside the system and freeze on the inner surface of the tubing and/or be expelled out toward the driver or passenger. Therefore, a dehumidification system that removes and collect the moisture could be advantageous to reduce the likelihood this would occur. One solution would be to include dry ice or another suitable coolant within the aforementioned inline dehumidification unit, whereby the dry ice is preferably isolated from the ambient air, but in contact with a series of elements, such as copper or aluminum rods (not shown), that extend into the pathway of the incoming ambient air and around which the air can flow on its way into the conduit 61 of the main refrigeration container 18. As the air contacts the cold rods/elements prior to entering the container 18, the water vapor freezes on the surfaces thereof so that the moisture content of the air is reduced. The elements for reducing air moisture content should be sized and spaced within the dehumidification unit so that they do not significantly impede air flow, particularly after ice build-up has occurred during a period of extended use. One the need for further air refrigeration is over, the coolant is removed to allow dissipation of the ice so that the unit can be reused. Under extreme circumstances, the unit or elements may need to be replaced or rotated with a second unit or group of elements during use (a race) if air flow obstruction is unavoidable due to significant ice buildup. Alternatively, a system or means to quickly or automatically scrap away ice build up may also be advantageous in these situations. Another solution is to temporarily divert hot air (such as from the engine compartment) to the inline dehumidification unit or include a heat source therein to melt ice buildup before it obstructs air flow. Periodically isolating the elements from the coolant is another strategy that may be used.

Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other details of construction are believed to be well within the ability of one of even rudimentary skills in this area, in view of the present disclosure. The designs described herein are intended to be exemplary only. The novel characteristics of the invention may be incorporated in other structural forms without departing from the spirit and scope of the invention. The invention encompasses embodiments both comprising and consisting of the elements described with reference to the illustrative embodiments.

What is claimed is:

1. A system for delivering refrigerated air to the passenger compartment of a vehicle, comprising:
a coolant container unit adapted to enclose a coolant material therewithin, the coolant container unit comprising an interior space and including at least one inflow port configured for directing accelerated ambient air flow into the coolant container and at least one outflow port for directing the refrigerated air from the coolant container unit to one or more locations external to the container unit;
an elongate tubular conduit disposed between the inflow and outflow port to comprise an airflow pathway traversing the coolant container unit, the airflow pathway being isolated from the interior space within the sealed coolant container such that sublimate from the coolant material does not mix with the accelerated ambient air; and
wherein the tubular conduit comprises a thermally conductive material configured in at least one of a coiled or serpentine pathway to extend contact between the conduit and the ambient air flowing therethrough.

2. The system of claim 1, wherein the conduit comprises a coiled configuration.

3. The system of claim 1, wherein the conduit within the coolant container unit comprises at least five coils.

4. The system of claim 1, wherein the airflow pathway is at least 8 feet in length.

5. The system of claim 1, wherein the coolant container unit further comprises a second conduit and a second airflow pathway extending therethrough.

6. The refrigerated air delivery system of claim 1, wherein a delivery conduit system extends between the outflow and a driver seat.

7. The refrigerated air delivery system of claim 1, wherein the coolant material comprises dry ice.

8. The refrigerated air delivery system of claim 1, wherein the system is configured such that the temperature of the refrigerated air delivered to the passenger compartment is less than 15° F. when the coolant is disposed within the container unit.

9. The refrigerated air delivery system of claim 1, wherein the system is configured such that the temperature of the refrigerated air delivered to the passenger compartment is less than 10° F. when the coolant material is disposed within the container unit.

10. The refrigerated air delivery system of claim 1, wherein the system is configured such that the temperature of the refrigerated air delivered to the passenger compartment is less than 5° F. when the coolant material is disposed within the container unit when the coolant material is disposed within the container unit.

11. The refrigerated air delivery system of claim 1, wherein the movement of airflow into the container unit is assisted by an accelerating device connectable to a power source.

12. The refrigerated air delivery system of claim 1, wherein the inflow and outflow ports of the coolant container unit are configured such that the movement of airflow therethrough is gravity assisted.

13. The refrigerated air delivery system of claim 1, further comprising a delivery conduit system configured to direct refrigerated air to a first location and a second location within the passenger compartment of the vehicle.

14. The refrigerated air delivery system of claim 1, further comprising a delivery conduit system that is configured such that the driver of the vehicle can selectively direct, adjust, or restrict the refrigerated air to the first and/or second location.

15. A system for delivering refrigerated air to the passenger compartment of a vehicle, comprising:
a coolant container unit adapted to enclose and at least substantially seal a coolant material therewithin, the coolant container unit including at least one inflow port configured for directing ambient air flow into the coolant container and at least one outflow port for directed the refrigerated air from the coolant container unit to one or more locations external to the container unit;
a metal conduit disposed between the inflow and outflow port to comprise an airflow pathway traversing the coolant container unit, the airflow pathway being isolated from the ambient space within the sealed coolant container such that sublimate from the coolant material generally does not enter the airflow pathway; and
wherein the outflow port is connected to a delivery conduit system that distributes the refrigerated air to a first location for cooling an occupant of the vehicle and at least a second location comprising a component of the vehicle.

16. The refrigerated air delivery system of claim 15, wherein the first location includes the driver of the vehicle and the second locations comprises a portion of the brake system of the vehicle.

17. The refrigerated air delivery system of claim 15, wherein the inflow port is connected to an inflow conduit.

18. The refrigerated air delivery system of claim 15, wherein the inflow port is connected to a powered air accelerating mechanism.

19. A method of refrigerating air within a vehicle, comprising the steps of:
providing a coolant container unit adapted to enclose and at least substantially seal a coolant material therewithin, the coolant container unit comprising an interior space and including at least one inflow port configured for directing accelerated ambient air flow into the coolant container and at least one outflow port for directing the refrigerated air from the coolant container unit to one or more locations external to the container unit, the cooler container unit further comprising an elongate tubular conduit comprising a thermally conductive material having at least one of a coiled and a serpentine configuration, the tubular conduit disposed between the inflow and outflow port to comprise an closed airflow pathway traversing the coolant container unit, the airflow pathway being isolated from the interior space within the sealed coolant container such that sublimate from the coolant material does not mix with the accelerated ambient air;
attaching the inflow port to a means for directing ambient air thereinto;
attaching the outflow port to an air delivery system configured to direct the refrigerated air to at least one location within the vehicle;
introducing a coolant material into the interior space of the coolant container unit such that it contacts the tubular conduit;
sealing the coolant container unit; and
accelerating the ambient air such that it traverses the coolant container unit via the tubular conduit such that ambient air is refrigerated thereby.

20. The method of claim 19, wherein the coolant material is dry ice.
